(19) United States
(12) Patent Application Publication
(10) Pub. No.: US 2026/0304567 A1
(43) Pub. Date: Oct. 1, 2026

(54) COOKING APPLIANCE

(71) Applicants: Guangdong Galanz Enterprises Co., Ltd., Foshan City (CN); Guangdong Galanz Appliances Manufacturing Co., Ltd., Zhongshan City (CN); Guangdong Galanz Microwave Oven and Electrical Appliances Manufacturing Co., Ltd., Foshan City (CN)

(72) Inventors: HaoSheng YANG, Foshan City (CN); DingFu LI, Foshan City (CN); WeiChang FENG, Foshan City (CN); ZhouPing WANG, Foshan City (CN)

(21) Appl. No.: 19/631,452

(22) Filed: Mar. 27, 2026

(30) Foreign Application Priority Data
Mar. 28, 2025 (CN) 202520569102.9
Mar. 28, 2025 (CN) 202520569764.6
Mar. 28, 2025 (CN) 202520569921.3
Mar. 31, 2025 (CN) 202520581293.0

(51) Int. Cl. H05B 6/64

(52) U.S. Cl. CPC H05B 6/6402; H05B 6/6414; H05B 6/642

(57) ABSTRACT

A cooking appliance comprising a thermal insulation cavity assembly is described. The thermal insulation cavity assembly comprises an inner cavity assembly and an insulation frame assembly sequentially arranged, an insulation member is disposed between the inner cavity assembly and the insulation frame assembly to which it is snap-fitted, and the insulation frame assembly is connected to the inner cavity assembly. The cooking appliance provides thermal insulation and heat blocking functions to prevent heat in the oven cavity from being transferred to the electrical cavity, avoiding excessive heat dissipation load in the electrical cavity or excessively high temperature in the electrical cavity and high-temperature damage to electrical components, while concentrating heat in the oven cavity to ensure a good temperature rise rate in the oven cavity to enable relatively rapid attainment of the required cooking temperature.

### CROSS-REFERENCE TO RELATED APPLICATIONS

This application claims priority to Chinese Patent Application No. 202520569764.6 filed with the China National Intellectual Property Administration (CNIPA) on Mar. 28, 2025, and Chinese Patent Application No. 202520581293.0 filed with CNIPA on Mar. 31, 2025, and Chinese Patent Application No. 202520569921.3 filed with CNIPA on Mar. 28, 2025, and Chinese Patent Application No. 202520569102.9 filed with CNIPA on Mar. 28, 2025, the disclosures of all of which are incorporated herein by reference in their entireties.

### FIELD

The present invention relates to a cooking appliance.

### BACKGROUND

With the continuous improvement of modern household demands for kitchen appliance performance, cooking appliance represented by cooking appliance and steam ovens, as commonly used kitchen appliances, has seen heating efficiency and heating uniformity become focal points of user concern. Traditional cooking appliance generally employs a single magnetron, introducing microwaves into the oven cavity through a single waveguide to heat food; however, due to the limited power and microwave radiation range of a single magnetron, this often results in uneven microwave distribution within the oven cavity. Particularly when heating larger or irregularly shaped food items, the heat received by different parts of the food varies significantly, affecting the heating effect. For this reason, dual-magnetron cooking appliance has emerged and gradually become representative of high-end cooking appliance products.

However, the oven cavity walls of existing cooking appliance all possess a certain degree of thermal conductivity, causing a portion of the heat within the oven cavity to be conducted to the outside of the oven cavity. This situation presents the following problems:
1. For dual-magnetron cooking appliance, the dual magnetrons installed in the electrical cavity are prone to generating more heat, leading to increased heat dissipation requirements for the electrical cavity. At this point, if the traditional oven cavity structure is still employed, as heat is transferred from the oven cavity to the electrical cavity, this will undoubtedly further increase the heat dissipation load of the electrical cavity, and is also liable to cause excessively high temperatures within the electrical cavity, even resulting in high-temperature damage to electrical components.
2. In low-voltage usage environments (such as Japan, which often uses 110V power), or when there are cooking requirements for higher temperatures (such as grilling functions), as a portion of the heat within the oven cavity is conducted to the outside of the oven cavity, this will cause the temperature rise rate within the oven cavity to slow down, or even make it difficult to reach the required cooking temperature, affecting cooking efficiency and cooking results.

For this reason, the present application is specifically proposed.

### SUMMARY

In view of this, the present invention aims to provide a cooking appliance to solve the problems existing in the prior art that heat in the oven cavity is easily conducted outward, resulting in an increased heat dissipation load in the electrical cavity or a slower heating rate in the oven cavity.

To achieve the above objective, the technical solution of the present invention is implemented as follows:

A cooking appliance, comprising a thermal insulation cavity assembly, the thermal insulation cavity assembly comprising an inner cavity assembly and an insulation frame assembly arranged sequentially from inside to outside, an insulation member is disposed between the inner cavity assembly and the insulation frame assembly, the insulation member is snap-fitted with the insulation frame assembly, and the insulation frame assembly is connected to the inner cavity assembly.

Further, at least a portion of the structure of the insulation frame assembly is connected to the inner cavity assembly through a fastener, a mounting space is formed between a side of the insulation frame assembly facing the inner cavity assembly and an outer side wall of the inner cavity assembly, and the insulation member is disposed in the mounting space.

Further, a plurality of limiting pieces are disposed on a side of the insulation frame assembly facing the inner cavity assembly, the limiting pieces abut against an outer edge of the insulation member, and/or, the insulation member is provided with insertion holes, and the limiting pieces are capable of penetrating through the insertion holes.

Further, the insulation frame assembly comprising a top frame, a left side frame, a bottom frame, a right side frame, and a rear frame, the top frame, the left side frame, the bottom frame, and the right side frame are sequentially connected end to end and enclose an accommodating space, the inner cavity assembly is disposed within the accommodating space; the rear frame is connected to the inner cavity assembly, and/or, the rear frame is connected to at least one of the top frame, the left side frame, the bottom frame, and the right side frame.

Further, the rear frame is at least connected to a rear plate of the inner cavity assembly.

Further, the cooking appliance comprising a front plate and a connecting member, the front plate is connected to the inner cavity assembly, and at least any one of the top frame, the left side frame, the bottom frame, and the right side frame is capable of being connected to the front plate through the connecting member.

Further, the cooking appliance comprising a door body, the connecting member is provided on a side of the front plate facing away from the door body, one end of the connecting member is engaged with the front plate, and the other end is connected to the top frame in a detachable manner.

Further, the connecting member comprising an engagement section, a transition reinforcement section, and a mounting section connected in sequence, the engagement section is engaged with the front plate, and the mounting section is connected to the top frame.

Further, the top frame is provided with a mounting protrusion, the mounting protrusion is provided with a mounting hole, the mounting section is provided with an installation hole, the mounting hole and the installation hole are connected through a fastener; the mounting protrusion is provided with an insertion opening, the mounting section is provided with an insertion plate, and the insertion plate is capable of being inserted into the insertion opening.

Further, a top portion of the front plate is provided with an upper flange, the upper flange has a insertion hole formed therein, a side of the engagement section facing away from the transition reinforcement section is provided with a front flange, the front flange is capable of being inserted into the insertion hole and abutting against the insertion hole; the upper flange is provided with an engagement recess on a side of the insertion hole facing away from the door body, a side of the engagement section adjacent to the upper flange forms an clamping groove, the front flange is inserted into the insertion hole, and the clamping groove is engaged with the engagement recess.

Further, the connecting member comprising an abutment section, an end of the engagement section remote from the transition reinforcement section is connected to the abutment section, and the abutment section is capable of at least abutting against the upper flange.

Further, the cooking appliance comprising a fixing member, the fixing member is disposed between the top frame and the top plate of the inner cavity assembly, and is connected to the top frame and the top plate.

Further, the top frame is provided with a fixing region, the top plate is provided with a mounting groove, a lower end of the fixing member is disposed in the mounting groove and is connected to the mounting groove, and an upper end of the fixing member is connected to the fixing region.

Further, the cooking appliance comprising a heating assembly, the heating assembly is disposed between the inner cavity assembly and the insulation member, and an insulation structure is provided on an outer side of the insulation frame assembly.

Further, the insulation member between the top plate of the inner cavity assembly and the top frame of the insulation frame assembly is designated as a top insulation member; the heating assembly is disposed between the top plate and the top insulation member, an upper insulation layer is provided on a side of the top frame remote from the top insulation member; and the top insulation member and the upper insulation layer are respectively engaged with the top frame.

Further, the heating assembly comprising a terminal, a first insulation sheet, a heating element, and a second insulation sheet arranged sequentially from top to bottom, wherein the terminal is connected to the heating element.

Further, the first insulation sheet is provided with a wire routing hole, and the terminal is connected to the heating element through the wire routing hole; the top frame is provided with an access port, the top insulation member is provided with a clearance opening, and the access port and the clearance opening are directly opposite to each other and both located above the terminal; the top frame is provided with a third insulation sheet above the access port, an upper surface of the top frame is provided with a limiting claw, and the third insulation sheet is capable of engaging with the limiting claw; the first insulation sheet, the second insulation sheet, and the third insulation sheet are all mica sheets.

Further, the cooking appliance comprising an exhaust structure, the rear plate of the inner cavity assembly is provided with an exhaust port, and the exhaust structure comprising:

a first exhaust cover, wherein the first exhaust cover is disposed at a rear side of the exhaust port, a first exhaust cavity is provided inside the first exhaust cover, and the exhaust port is in communication with the first exhaust cavity;

a second exhaust cover, wherein the first exhaust cover is disposed inside the second exhaust cover, a second exhaust cavity is provided inside the second exhaust cover, the first exhaust cavity is in communication with the second exhaust cavity, and the first exhaust cover and the second exhaust cover are separately provided.

Further, the second exhaust cover is provided with an accommodating cavity for mounting the first exhaust cover, the second exhaust cavity is arranged above the accommodating cavity, and the second exhaust cavity is arranged vertically inside the second exhaust cover.

Further, the cooking appliance comprising a rear housing, the rear housing is arranged on a rear side of the rear plate, the first exhaust cover and the second exhaust cover are respectively connected to the rear housing; a sealing connection sleeve is arranged on a side of the first exhaust cover adjacent to the exhaust port, and the sealing connection sleeve is sealingly connected to the rear plate.

Compared to the prior art, the cooking appliance according to the present invention has the following advantages:

Compared with the oven cavity of conventional cooking appliance, the cooking appliance according to the present invention can effectively prevent heat in the oven cavity from being transferred to the outside. On the one hand, it provides thermal insulation and heat resistance, preventing heat in the oven cavity from being transferred to the electrical cavity, thereby avoiding excessive heat dissipation load in the electrical cavity due to heat transfer, and even preventing situations where the temperature in the electrical cavity becomes too high and electrical components are damaged by high temperature. On the other hand, it can effectively concentrate heat in the oven cavity, ensuring that the oven cavity has a good heating rate and can relatively quickly reach the cooking temperature requirement (such as the extremely high temperature cooking requirement under the grilling function), which helps to improve cooking efficiency and ensure cooking performance. Correspondingly, the present application also reduces the energy loss and energy waste caused by heat transfer from the oven cavity to the outside, and under the same cooking conditions, can effectively reduce electrical energy consumption.

### DESCRIPTION OF DRAWINGS

The accompanying drawings forming part of the present invention are provided to furnish further understanding of the present invention, and the schematic embodiments of the present invention and descriptions thereof are used to explain the present invention and do not constitute an improper limitation thereof. In the drawings:

FIG. 1 is an exploded view of cooking appliance according to an embodiment of the present invention;

FIG. 2 is an exploded view of the thermal insulation cavity assembly according to an embodiment of the present invention;

FIG. 3 is an exploded view of the inner cavity assembly according to an embodiment of the present invention;

FIG. 4 is an exploded view of the insulation frame assembly according to an embodiment of the present invention;

FIG. 5 is another exploded view of the insulation frame assembly according to an embodiment of the present invention;

FIG. 6 is a structural schematic diagram of the top frame according to an embodiment of the present invention (oblique perspective from top to bottom);

FIG. 7 is a structural schematic diagram of the top frame from another perspective according to an embodiment of the present invention (oblique perspective from bottom to top);

FIG. 8 is a schematic structural diagram of the left side frame according to an embodiment of the present invention (oblique viewing angle from right to left);

FIG. 9 is a schematic structural diagram of the right side frame according to an embodiment of the present invention (oblique viewing angle from left to right);

FIG. 10 is a schematic structural diagram of the bottom frame according to an embodiment of the present invention (oblique viewing angle from top to bottom);

FIG. 11 is a schematic structural diagram of the rear frame according to an embodiment of the present invention (oblique viewing angle from front to rear);

FIG. 12 is a partial enlarged view at location A in FIG. 1 according to an embodiment of the present invention;

FIG. 13 is a schematic structural diagram of the top frame and top plate according to an embodiment of the present invention;

FIG. 14 is an exploded view of the top frame in another component structural form according to an embodiment of the present invention;

FIG. 15 is a schematic structural diagram of the positioning assembly according to an embodiment of the present invention;

FIG. 16 is a schematic structural diagram of the connecting member according to an embodiment of the present invention;

FIG. 17 is a schematic structural diagram of the front plate according to an embodiment of the present invention;

FIG. 18 is a structural schematic diagram of the top frame according to an embodiment of the present invention;

FIG. 19 is a schematic diagram of cooking appliance according to an embodiment of the present invention (rear view);

FIG. 20 is a partially enlarged view at position B in FIG. 19 according to an embodiment of the present invention;

FIG. 21 is a schematic diagram of cooking appliance with the door body removed according to an embodiment of the present invention;

FIG. 22 is a cross-sectional view of cooking appliance according to an embodiment of the present invention;

FIG. 23 is a partially enlarged view at position C in FIG. 22 according to an embodiment of the present invention;

FIG. 24 is a structural exploded view of cooking appliance according to an embodiment of the present invention (rear view);

FIG. 25 is a partially enlarged view at position D in FIG. 24 according to an embodiment of the present invention;

FIG. 26 is a partially enlarged view at position E in FIG. 24 according to an embodiment of the present invention;

FIG. 27 is a perspective view of the first exhaust cover according to an embodiment of the present invention;

FIG. 28 is a schematic structural diagram of the first exhaust cover according to an embodiment of the present invention;

FIG. 29 is a schematic structural diagram of the second exhaust cover according to an embodiment of the present invention;

FIG. 30 is a perspective view of the second exhaust cover according to an embodiment of the present invention;

FIG. 31 is a schematic structural diagram of the sealing connection sleeve according to an embodiment of the present invention.

### DESCRIPTION OF REFERENCE NUMBERS

1. thermal insulation cavity assembly; 11. inner cavity assembly; 110. cooking cavity; 111. top plate; 1111. mounting groove; 112. left side plate; 113. bottom plate; 114. right side plate; 115. rear plate; 1151. exhaust port; 1152. exhaust protrusion; 12. fixing member; 121. mounting base plate; 122. first insertion plate; 123. protrusion; 2. insulation frame assembly; 20. insulation member; 201. top insulation member; 2011. clearance opening; 2012. first limiting opening; 21. top frame; 211. left flange; 2111. first groove; 212. right flange; 2121. second groove; 213. fixing region; 214. first insertion opening; 215. first fixing hole; 216. access port; 217. limiting claw; 218. third insulation sheet; 219. mounting protrusion; 2191. insertion opening; 2192. mounting hole; 22. left side frame; 221. top flange; 222. bottom flange; 23. bottom frame; 231. left turned plate; 2311. third groove; 232. right turned plate; 2321. fourth groove; 24. right side frame; 241. upper turned plate; 242. lower turned plate; 25. rear frame; 251. aperture; 252. first slot; 26. upper insulation layer; 27. limiting piece; 28. mounting space; 3. heating assembly; 31. terminal; 32. first insulation sheet; 321. wire routing hole; 322. second limiting opening; 33. heating element; 34. second insulation sheet; 341. third limiting opening; 101. door body; 102. main housing; 103. rear housing; 1031. fifth connection hole; 1032. sixth connection hole; 1033. seventh connection hole; 1034. eighth connection hole; 1035. second slot; 104. base; 105. electrical cavity; 106. front plate; 1061. upper flange; 1062. insertion hole; 1063. engagement recess; 4. connecting member; 41. abutment section; 42. engagement section; 421. clamping groove; 422. front flange; 43. transition reinforcement section; 431. reinforcement protrusion; 432. side flange; 44. mounting section; 441. installation hole; 442. insertion plate; 5. first exhaust cover; 51. first exhaust cavity; 511. first inlet; 512. first outlet; 52. first connection hole; 53. second connection hole; 54. first connection protrusion; 55. second connection protrusion; 56. limiting protrusion; 57. limiting edge; 58. reinforcing edge; 59. reinforcing structure; 6. second exhaust cover; 61. second exhaust cavity; 62. accommodating cavity; 63. first relief groove; 64. second relief groove; 65. third connection hole; 66. fourth connection hole; 7. sealing connection sleeve; 71. connection edge; 72. limiting groove.

### DETAILED DESCRIPTION

The inventive concepts of the present disclosure will be described hereinafter using terms commonly employed by those skilled in the art to convey the substance of their work to others skilled in the art. However, these inventive concepts may be embodied in many different forms and should not be construed as limited to the embodiments described herein.

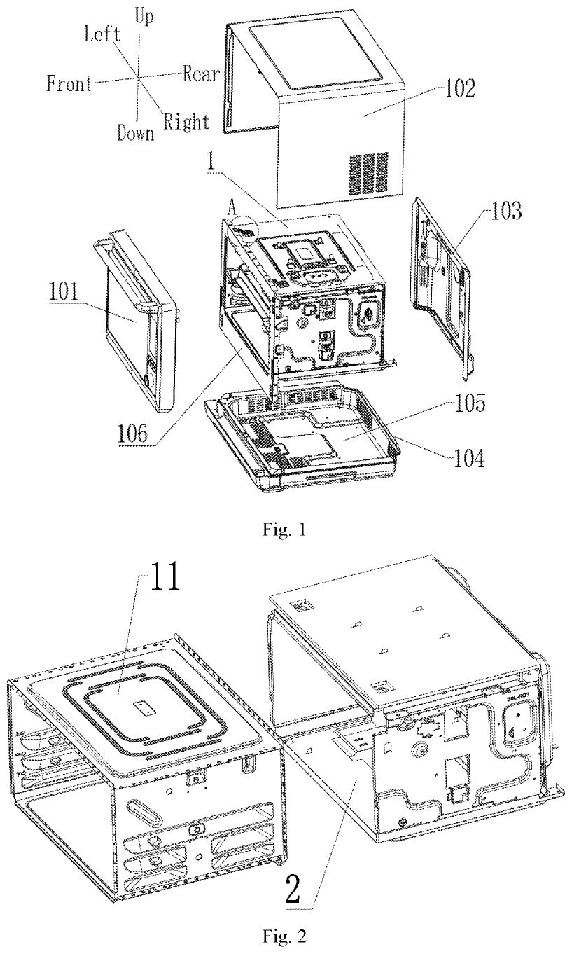

It should be noted that, in the absence of conflict, the embodiments in the present invention and the features in the embodiments may be combined with each other. The directional terms in this application are all based on the orientation of the cooking appliance in a conventional assembled and placed state, with reference to the coordinates in FIG. 1.

The present invention will be described in detail below with reference to the accompanying drawings and in conjunction with the embodiments.

### Embodiment 1

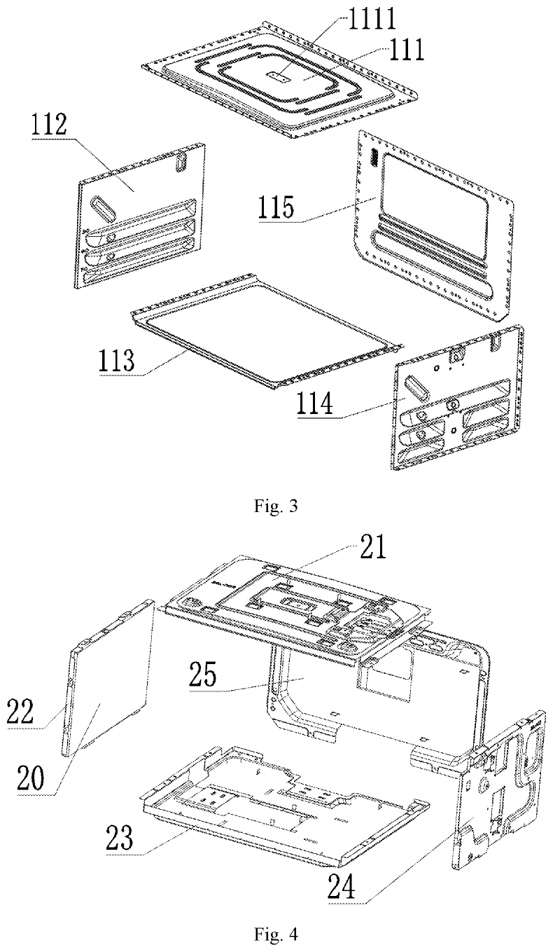

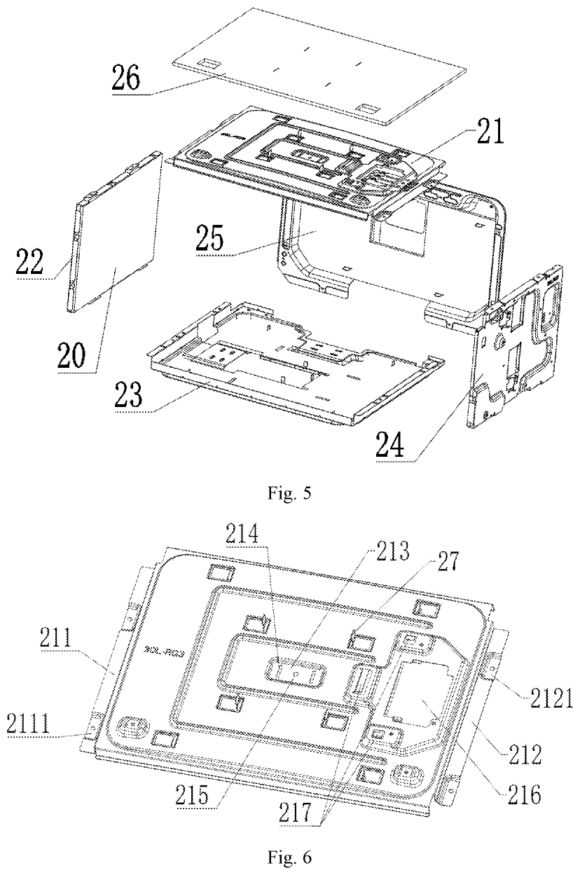

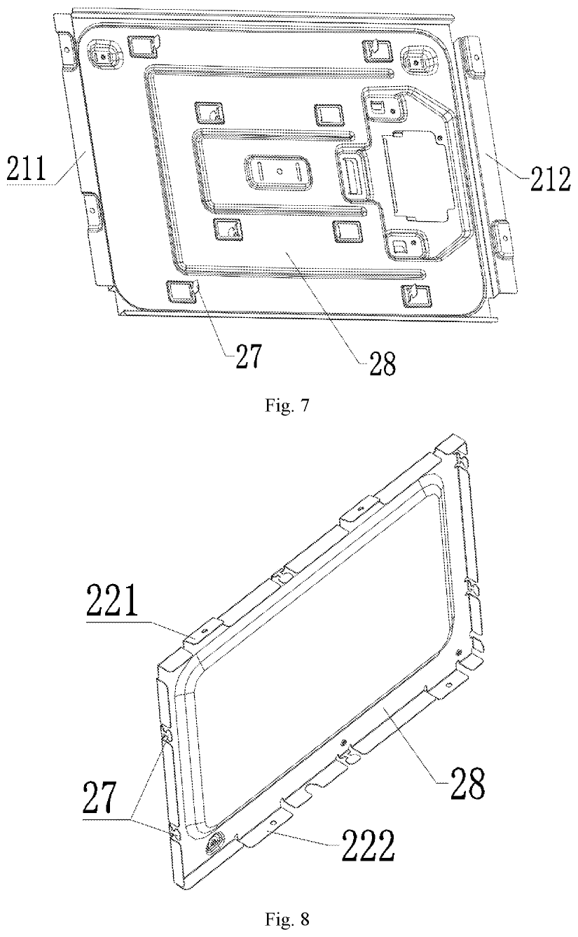

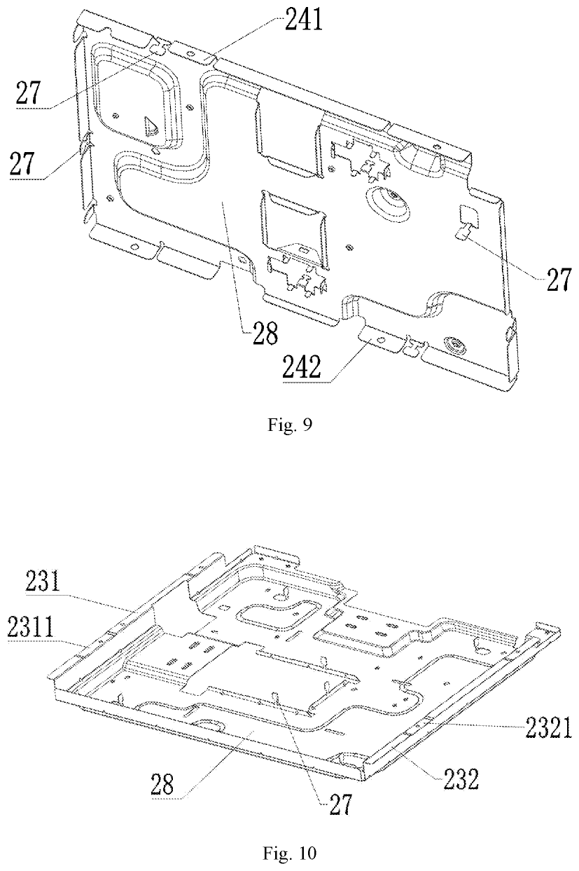

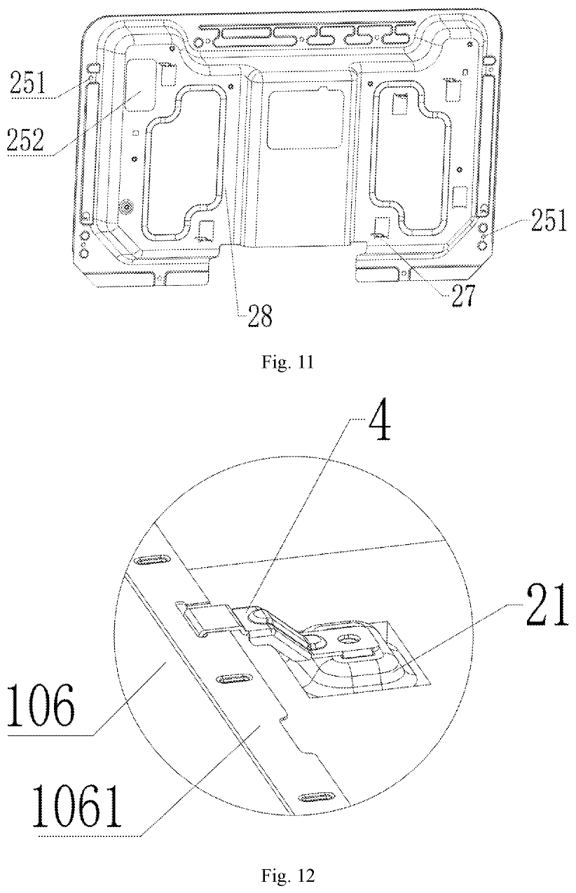

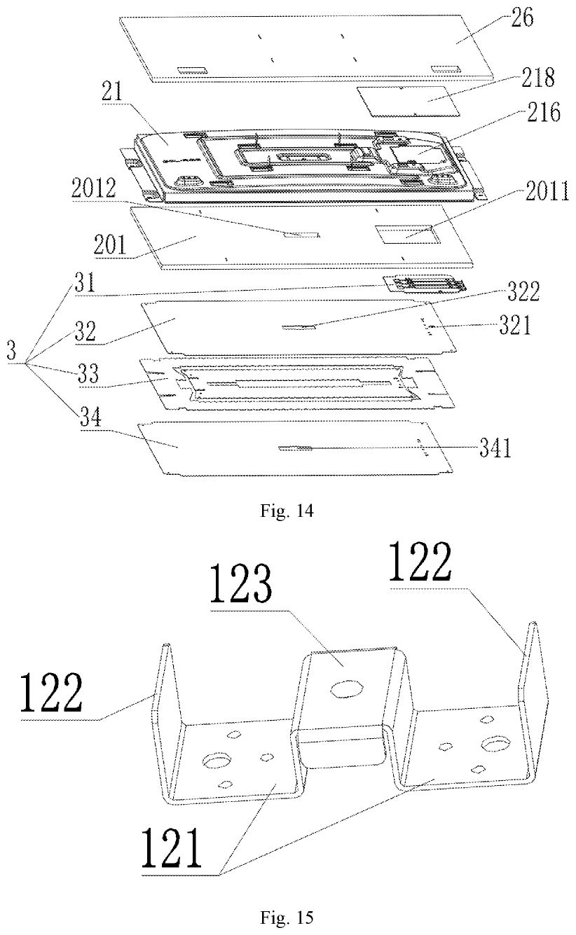

In order to solve the problems existing in the prior art that heat in the oven cavity is easily conducted outward, resulting in an increased heat dissipation load in the electrical cavity or a slower temperature rise rate in the oven cavity, this embodiment proposes a cooking appliance, as shown in FIGS. 1-15. The cooking appliance includes a thermal insulation cavity assembly 1, and the thermal insulation cavity assembly 1 includes an inner cavity assembly 11 and an insulation frame assembly 2 arranged sequentially from inside to outside. An insulation member 20 is provided between the inner cavity assembly 11 and the insulation frame assembly 2, the insulation member 20 is engaged with the insulation frame assembly 2, and the insulation frame assembly 2 is connected to the inner cavity assembly 11.

The inner cavity assembly 11 has the same structure as the inner cavity of conventional cooking appliance, having a top plate 111, a left side plate 112, a bottom plate 113, a right side plate 114, and a rear plate 115. The connection between the various plates and whether they are integrally or separately arranged can refer to the prior art and will not be elaborated here. As for the material of the insulation member 20, it can be conventional insulation cotton or other conventional insulation materials, and this application does not impose specific limitations on it. In this application, the outer side wall of the top plate 111, the outer side wall of the left side plate 112, the outer side wall of the bottom plate 113, the outer side wall of the right side plate 114, and the outer side wall of the rear plate 115 are all provided with insulation members 20, which are assembled and fixed by the insulation frame assembly 2.

Thus, in this application, insulation members 20 are arranged surrounding the entire outer side wall of the inner cavity assembly 11 and are assembled and fixed by the insulation frame assembly 2 to form the thermal insulation cavity assembly 1. Compared with the oven cavity of conventional cooking appliance, this can effectively prevent heat in the oven cavity from being transferred to the outside. On the one hand, it provides thermal insulation and heat blocking, preventing heat in the oven cavity from being transferred to the electrical cavity 105 (the electrical components in the electrical cavity 105, such as magnetrons, are omitted in FIG. 1), avoiding an excessive heat dissipation load in the electrical cavity 105 due to heat transfer, and even preventing situations where the temperature in the electrical cavity 105 is too high and electrical components are damaged by high temperature. On the other hand, it can effectively concentrate heat in the oven cavity, ensuring a good temperature rise rate in the oven cavity, and enabling the cooking temperature requirement to be reached relatively quickly (such as extremely high temperature cooking requirements under grilling function), which helps improve cooking efficiency and ensure cooking effects. Correspondingly, this application also reduces energy loss and energy waste caused by heat transfer from the oven cavity to the outside. Under the same cooking conditions, it can effectively reduce the consumption of electrical energy.

At least part of the structure of the insulation frame assembly 2 is connected to the inner cavity assembly 11 through fasteners, a mounting space 28 is formed between the side of the insulation frame assembly 2 facing toward the inner cavity assembly 11 and the outer wall of the inner cavity assembly 11, and the insulation member 20 is disposed in the mounting space 28, so that the insulation frame assembly 2 and the inner cavity assembly 11 can be assembled relatively securely, and at the same time the insulation member 20 can also be disposed relatively securely between the insulation frame assembly 2 and the inner cavity assembly 11. Since the insulation member 20 often has a certain deformation capacity, the insulation member 20 is disposed in the mounting space 28 in an interference fit manner to further ensure the secure installation of the insulation member 20.

For the assembly of the insulation member 20, a plurality of limiting pieces 27 are provided on the side of the insulation frame assembly 2 facing toward the inner cavity assembly 11, the limiting pieces 27 abut against the outer edge of the insulation member 20, and/or the insulation member 20 is provided with insertion holes, and the limiting pieces 27 can penetrate through the insertion holes, thereby achieving snap engagement between the insulation member 20 and the insulation frame assembly 2.

For the entire insulation frame assembly 2, it includes a top frame 21, a left side frame 22, a bottom frame 23, a right side frame 24, and a rear frame 25. The top frame 21, the left side frame 22, the bottom frame 23, and the right side frame 24 are sequentially connected end to end and enclose an accommodating space. The inner cavity assembly 11 is disposed within the accommodating space. The rear frame 25 is connected to the inner cavity assembly 11, and/or the rear frame 25 is connected to at least one of the top frame 21, the left side frame 22, the bottom frame 23, and the right side frame 24. That is, the structure of the insulation frame assembly 2 of the present application is similar to that of the inner cavity assembly 11, both having five parts: top, left, bottom, right, and rear, so that the cooking appliance is provided with insulation members 20 on all five surfaces except the front surface, thereby improving the effects of heat insulation, heat blocking, and heat retention.

Correspondingly, the top frame 21 corresponds to the top plate 111 of the inner cavity assembly 11, a mounting space 28 is formed therebetween, and an insulation member 20 is disposed. Meanwhile, the top frame 21 is provided with limiting pieces 27 extending toward the top plate 111 to limit the insulation member 20. For the left side frame 22, the bottom frame 23, the right side frame 24, and the rear frame 25, they also respectively correspond one-to-one with the left side plate 112, the bottom plate 113, the right side plate 114, and the rear plate 115 of the inner cavity assembly 11, also correspondingly forming mounting spaces 28 and being provided with corresponding insulation members 20, and are also provided with corresponding limiting pieces 27 to limit the corresponding insulation members 20, which will not be repeated one by one.

Regarding the connection of the rear frame 25, the present application preferably provides that: the rear frame 25 is at least connected to the rear plate 115 of the inner cavity assembly 11, for example, connected through fasteners. Correspondingly, the rear frame 25 is provided with corresponding apertures 251. Of course, if other plate structures of the inner cavity assembly 11 are connected to the rear plate 115 through bent flanges, then the rear frame 25 can also be connected together with the rear plate 115 to other plate structures of the inner cavity assembly 11.

Based on this, and out of consideration for the assembly reliability between the insulation frame assembly 2 and the inner cavity assembly 11, in the present application, on the basis of the rear frame 25 being connected to the rear plate 115, the rear frame 25 may also be connected to at least one of the top frame 21, the left side frame 22, the bottom frame 23, and the right side frame 24. This may serve as a first implementation approach to achieve reliable assembly between the insulation frame assembly 2 and the inner cavity assembly 11.

This embodiment also proposes a second implementation approach. Referring to FIGS. 1 and 12, the cooking appliance includes a front plate 106, and the front plate 106 is connected to the inner cavity assembly 11, which is the same as in the prior art and will not be elaborated upon. Based on this, the cooking appliance includes a connecting member 4, and at least any one of the top frame 21, the left side frame 22, the bottom frame 23, and the right side frame 24 can be connected to the front plate 106 through the connecting member 4. Thus, while the rear frame 25 is connected to the rear plate 115, the framework formed by the top frame 21, the left side frame 22, the bottom frame 23, and the right side frame 24 can also be connected to the inner cavity assembly 11 through the connection relationship between the connecting member 4 and the front plate 106, thereby also achieving reliable assembly between the insulation frame assembly 2 and the inner cavity assembly 11. At the same time, when the door of the cooking appliance is opened, the connecting member 4 can apply a force to the front plate 106 in a direction away from the door body 101, preventing loosening between the front plate 106 and the cavity structure due to door opening, and correspondingly preventing gaps from forming between the front plate 106 and the cavity structure, which would cause microwave leakage and endanger user health.

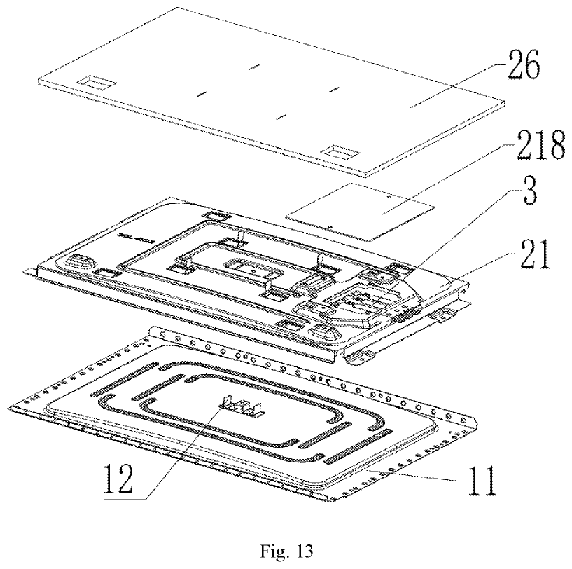

In addition, this embodiment also proposes a third implementation approach. Referring to FIG. 13, the cooking appliance includes a fixing member 12, and the fixing member 12 is disposed between the top frame 21 and the top plate 111 of the inner cavity assembly 11 and is connected to the top frame 21 and the top plate 111 respectively, thereby also achieving reliable assembly between the insulation frame assembly 2 and the inner cavity assembly 11.

Specifically, the top frame 21 is provided with a fixing region 213, the top plate 111 is provided with an mounting groove 1111, the lower end of the fixing member 12 is disposed in the mounting groove 1111 and is connected to the mounting groove 1111, and the upper end of the fixing member 12 is connected to the fixing region 213. For example: the fixing member 12 includes a mounting base plate 121, the mounting base plate 121 is provided with a protrusion 123, the protrusion 123 extends upward, and the protrusion 123 is connected to the fixing region 213 through a fastener. Correspondingly, the fixing region 213 is provided with a first fixing hole 215; the mounting base plate 121 is connected to the mounting groove 1111 through a fastener.

To improve assembly convenience, both sides of the fixing member 12 are provided with upwardly extending first insertion plates 122, the fixing region 213 is provided with first insertion openings 214, and the first insertion plates 122 can be inserted into the first insertion openings 214. Thus, during assembly, a positioning pre-assembly can be formed through the first insertion plates 122 and the first insertion openings 214, which helps improve the assembly convenience between the top frame 21 and the fixing member 12.

Of course, the present application is not limited to these three implementation approaches, and may also be any combination of these three implementation approaches.

Referring to FIGS. 6-11, the components of the insulation frame assembly 2 are described in this application.

A left flange 211 is disposed on the left side of the top frame 21, and a right flange 212 is disposed on the right side of the top frame 21. The left flange 211 is provided with a first groove 2111, and the right flange 212 is provided with a second groove 2121. A top flange 221 is disposed on the upper side of the left side frame 22, and the top flange 221 is connected to the first groove 2111. An upper turned plate 241 is disposed on the upper side of the right side frame 24, and the upper turned plate 241 is connected to the second groove 2121, thereby achieving connection among the top frame 21, the left side frame 22, and the right side frame 24. Preferably, the top frame 21, the left side frame 22, and the right side frame 24 are connected by fasteners.

A left turned plate 231 is disposed on the left side of the bottom frame 23, and a right turned plate 232 is disposed on the right side of the bottom frame 23. The left turned plate 231 is provided with a third groove 2311, and the right turned plate 232 is provided with a fourth groove 2321. A bottom flange 222 is disposed on the lower side of the left side frame 22, and the bottom flange 222 is connected to the third groove 2311. A lower turned plate 242 is disposed on the lower side of the right side frame 24, and the lower turned plate 242 is connected to the fourth groove 2321, thereby achieving connection among the bottom frame 23, the left side frame 22, and the right side frame 24. Preferably, the bottom frame 23, the left side frame 22, and the right side frame 24 are connected by fasteners.

### Embodiment 2

This embodiment provides further introduction based on Embodiment 1, specifically addressing the problem that conventional cooking appliance has difficulty providing extremely high-temperature cooking functions (such as grilling function) or has poor extremely high-temperature cooking performance.

It should be noted first that the cooking appliance in this embodiment also has a bottom heater (not shown), which is disposed inside the inner cavity assembly 11 and located on the bottom plate 113 of the inner cavity assembly 11, which is the same as the prior art and will not be described in detail.

In addition, as shown in FIGS. 1-15, the cooking appliance includes a heating assembly 3, the heating assembly 3 is disposed between the inner cavity assembly 11 and the insulation member 20, and an insulation structure is provided on the outer side of the insulation frame assembly 2.

Thus, in addition to the conventional bottom heater, this embodiment additionally provides a heating assembly 3 between the inner cavity assembly 11 and the insulation member 20 to directly heat the plate structure of the inner cavity assembly 11. On one hand, this can provide more heat to the oven cavity, enabling the cooking appliance to provide higher cooking temperatures and achieve extremely high-temperature cooking functions. On the other hand, by heating the inner cavity assembly 11, the heat is then conducted from the plate structure of the entire inner cavity assembly 11 to the oven cavity, which can improve the uniformity of temperature distribution within the oven cavity, ensure extremely high-temperature cooking performance for food, and prevent local burning of food.

At the same time, based on the beneficial effects of heat insulation, heat blocking, and heat accumulation in Embodiment 1, this embodiment further provides an insulation structure on the outer side of the insulation frame assembly 2, forming a double-layer insulation structure that reduces heat conduction outward, which helps to further improve cooking efficiency and ensure cooking performance.

The present application can position the heating assembly 3 at any location between the inner cavity assembly 11 and the insulation member 20. Of course, the outer side walls of the insulation frame assembly 2 can all be provided with an insulation structure, or an insulation structure can be provided on one or several side walls.

However, in comprehensive consideration of factors such as the overall volume of the thermal insulation cavity assembly 1, the heat superposition situation between the heating assembly 3 and the bottom heater, and the degree of high-temperature influence on the electrical cavity 105, the present application proposes a preferred solution, specifically as follows:

For ease of description, the insulation member 20 between the top plate 111 of the inner cavity assembly 11 and the top frame 21 of the insulation frame assembly 2 is designated as the top insulation member 201; the heating assembly 3 is disposed between the top plate 111 and the top insulation member 201, an upper insulation layer 26 is provided on a side of the top frame 21 away from the top insulation member 201, and the upper insulation layer 26 is engaged with the top frame 21.

Thus, this embodiment preferably provides the heating assembly 3 in the top structure of the thermal insulation cavity assembly 1, and additionally provides an upper insulation layer 26. On one hand, it can be disposed opposite to the conventional bottom heater, so that heat can be uniformly distributed throughout the oven cavity from top to bottom and from bottom to top, without local overheating occurring. On the other hand, because in conventional cooking appliance, the electrical cavity is often at a certain distance from the top of the cooking appliance (for example, the electrical cavity 105 of the present application is disposed on the base 104 of the cooking appliance), and combined with the double-layer insulation structure, the heat provided by the heating assembly 3 will not affect the heat dissipation load of the electrical cavity 105.

In addition, this embodiment preferably provides the upper insulation layer 26 only on the top frame 21, so as to ensure that the thermal insulation cavity assembly 1 has a good insulation effect while minimizing the overall volume of the thermal insulation cavity assembly 1 as much as possible. With regard to the engagement between the top frame 21 and the upper insulation layer 26, the top wall of the top frame 21 is provided with limiting pieces 27 extending upward, the limiting pieces 27 abut against the outer edge of the upper insulation layer 26, and/or the upper insulation layer 26 is provided with insertion openings, and the limiting pieces 27 can penetrate through the insertion openings.

The heating assembly 3 includes a terminal 31, a first insulation sheet 32, a heating element 33, and a second insulation sheet 34 arranged sequentially from top to bottom, the terminal 31 is connected to the heating element 33, and the heating element 33 may be a conventional heating wire, heating plate, or the like. Thus, on the basis of ensuring the provision of a heating function, the first insulation sheet 32 is provided between the top insulation member 201 and the heating element 33, and the second insulation sheet 34 is provided between the top plate 111 and the heating element 33, so as to prevent the thermal insulation cavity assembly 1 from becoming electrified and causing an electric shock accident to the user. The first insulation sheet 32 is provided with a wire routing hole 321, and the terminal 31 can be electrically connected to the heating element 33 through the wire routing hole 321.

Since the heating assembly 3 is disposed in the sandwich structure of the thermal insulation cavity assembly 1, in order to facilitate wiring and maintenance of the heating assembly 3, the top frame 21 is provided with an access port 216, the top insulation member 201 is provided with a clearance opening 2011, and the access port 216 and the clearance opening 2011 are directly opposite and both located above the terminal 31, so that by removing the upper insulation layer 26, wiring, routing, maintenance and other work on the heating assembly 3 can be performed through the access port 216 and the clearance opening 2011.

In order to avoid unnecessary electric shock risks, the top frame 21 is provided with a removable third insulation sheet 218 above the access port 216, the upper surface of the top frame 21 is provided with limiting claws 217, and the third insulation sheet 218 can be engaged with the limiting claws 217, so that on the one hand, safety risks at the access port 216 from the heating assembly 3 can be avoided, and on the other hand, the detachable arrangement of the third insulation sheet 218 facilitates maintenance operations and can prevent external foreign objects from entering through the access port 216.

The first insulation sheet 32, the second insulation sheet 34, and the third insulation sheet 218 are all preferably mica sheets, which have good insulation performance.

For the configuration in Embodiment 1 where the top frame 21 and the top plate 111 are connected by the fixing member 12, this embodiment can still retain this implementation. However, it should be noted that the top insulation member 201 is provided with a first limiting opening 2012, the first insulation sheet 32 is provided with a second limiting opening 322, and the second insulation sheet 34 is provided with a third limiting opening 341, such that one side of the fixing member 12 is connected to the top plate 111, and the other side extends upward and sequentially penetrates through the third limiting opening 341, the second limiting opening 322, and the first limiting opening 2012, and is connected to the top frame 21. Thus, on the one hand, unnecessary spatial interference due to the arrangement of the heating assembly 3 is avoided, and on the other hand, through the multiple limiting openings, the top insulation member 201 and the heating assembly 3 are limited with respect to the fixing member 12, which to a certain extent is beneficial to improving the connection reliability between components such as the top frame 21, the heating assembly 3, and the top plate 111. For the heating element 33, it is only necessary to simply bypass the corresponding limiting openings during arrangement, and spatial interference between the heating element 33 and the fixing member 12 will not occur.

### Embodiment 3

Based on Embodiment 1, for existing pull-down door type cooking appliance, during each pull-down door opening process (especially at the moment of door opening), there will be interaction forces between the door body and the front plate. Over time, this will cause loosening between the front plate and the cavity of the cooking appliance, which not only easily induces damage and deformation of components, but also easily forms gaps between the front plate and the cavity, resulting in microwave leakage and endangering user health.

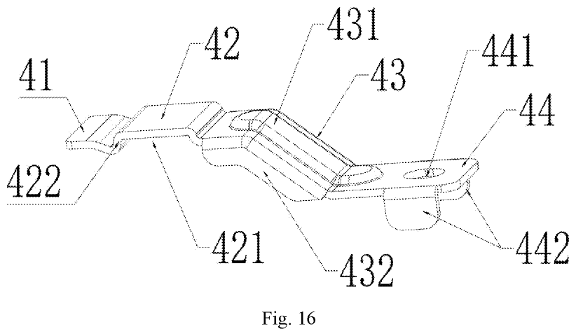

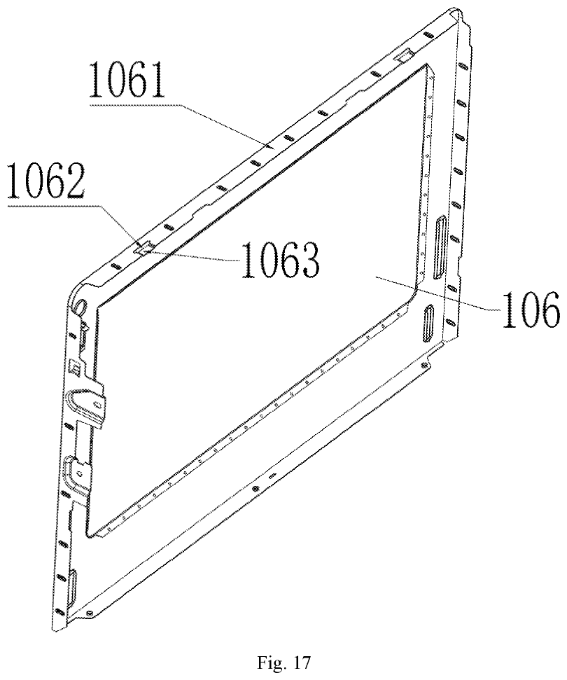

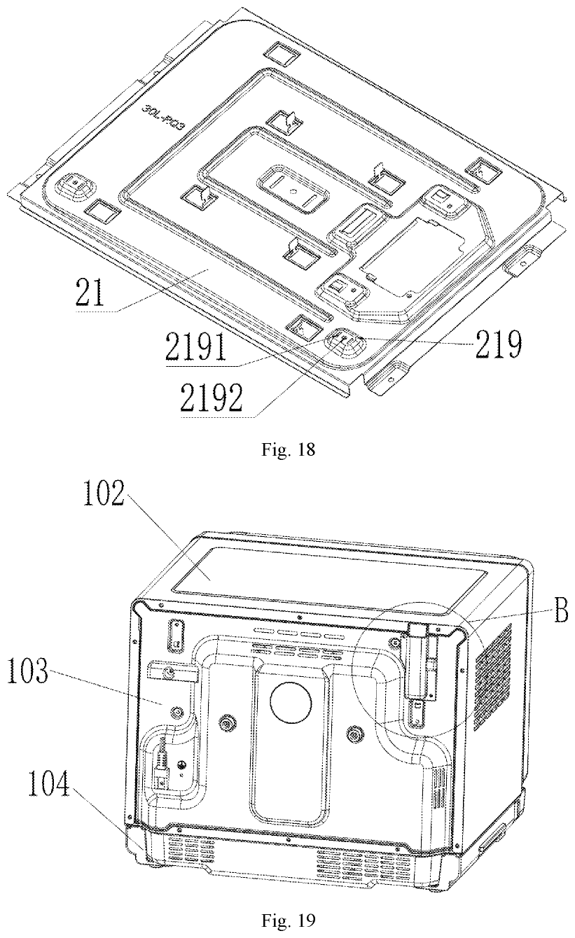

In order to solve the problem in the prior art that pull-down door type cooking appliance easily causes loosening between the front plate and the cavity as the door opening action proceeds, as shown in FIGS. 1, 12, and 16-18, the present application, based on Embodiment 1, further introduces specific details related to the connecting member 4.

The cooking appliance includes a door body 101. The connecting member 4 is disposed on a side of the front plate 106 away from the door body 101. One end of the connecting member 4 is engaged with the front plate 106, and the other end is detachably connected to the top frame 21, such that when the cooking appliance opens the door, the connecting member 4 can apply a force to the front plate 106 in a direction away from the door body 101, thereby avoiding loosening between the front plate 106 and the cavity structure due to door opening, and correspondingly avoiding the formation of gaps between the front plate 106 and the cavity structure, which would result in microwave leakage and endanger user health.

Thus, compared with the prior art, the present application, by additionally providing the connecting member 4, transfers the interaction force between the door body 101 and the front plate 106 to the connecting member 4 under door opening conditions. On the one hand, this avoids loosening between the front plate and the cavity caused by door opening, achieving a reinforcing effect on the front plate 106. On the other hand, the connecting member 4 is simple to install and remove, so that even if the connecting member 4 undergoes deformation due to frequent force application, the connecting member 4 can be easily disassembled and replaced.

The connecting member 4 includes a sequentially connected engagement section 42, transition reinforcement section 43, and mounting section 44, wherein the engagement section 42 engages with the front plate 106, and the mounting section 44 connects with the top frame 21. Meanwhile, while achieving the assembly of the connecting member 4, the transition reinforcement section 43, on the one hand, can provide a certain spatial transition to avoid unnecessary spatial interference, and on the other hand, helps to provide a reinforcing effect on the entire connecting member 4, improving its mechanical properties.

The top frame 21 is provided with a mounting protrusion 219, the mounting protrusion 219 is provided with a mounting hole 2192, the mounting section 44 is provided with an installation hole 441, and the mounting hole 2192 and the installation hole 441 can be connected by a fastener. By providing the mounting protrusion 219 on the top frame 21, the stress distribution at the assembly position with the connecting member 4 can be improved, which helps to improve the mechanical properties of the top frame 21.

The mounting protrusion 219 is provided with an insertion opening 2191, the mounting section 44 is provided with an insertion plate 442, and the insertion plate 442 can be inserted into the insertion opening 2191. On the one hand, this enables the connecting member 4 and the top frame 21 to form a pre-assembly through the insertion plate 442 and the insertion opening 2191 during the assembly process, providing assembly positioning function and facilitating subsequent installation of the fastener. On the other hand, it can also provide an engagement limiting effect to a certain extent, which helps to improve assembly reliability.

The transition reinforcement section 43 is provided with a reinforcement protrusion 431, and both sides of the transition reinforcement section 43 are provided with side flanges 432. On the one hand, this can improve the stress distribution of the connecting member 4 itself, which helps to improve the mechanical properties of the connecting member 4. On the other hand, it can provide allowance for slight deformation of the connecting member 4 under stress.

Regarding the connection between the front plate 106 and the connecting member 4, the top of the front plate 106 is provided with an upper flange 1061, the upper flange 1061 is provided with an insertion hole 1062, and the side of the engagement section 42 away from the transition reinforcement section 43 is provided with a front flange 422. The front flange 422 can be inserted into the insertion hole 1062 and abut against the insertion hole 1062, thereby achieving engagement between the front plate 106 and the connecting member 4. Meanwhile, under the door-opening condition, the front flange 422 can abut against the insertion hole 1062, and can apply a force on the front plate 106 in a direction away from the door body 101, avoiding loosening between the front plate and the cavity due to door opening.

The upper flange 1061 is provided with an engagement recess 1063 on a side of the insertion hole 1062 away from the door body 101. The engagement section 42 forms a clamping groove 421 on a side close to the upper flange 1061. When the front flange 422 is inserted into the insertion hole 1062, the clamping groove 421 engages with the engagement recess 1063 to ensure the reliability of the engagement between the front plate 106 and the connecting member 4. For example, the engagement section 42 has an arched structure, with its front side being designated as the front flange 422 and inserted into the insertion hole 1062. The entire arched structure can form the clamping groove 421, and an engagement is formed between the clamping groove 421 and the engagement recess 1063. Meanwhile, the provision of the engagement recess 1063 also enables the front flange 422 to be inserted into the insertion hole 1062 more conveniently, thereby reducing the difficulty of disassembly and assembly.

Furthermore, due to the provision of the engagement recess 1063, the connecting member 4 can also be inserted into the insertion hole 1062 along an inclined downward direction, providing a certain assembly angle. On this basis, in order to further enhance the engagement relationship between the front plate 106 and the connecting member 4, the connecting member 4 includes an abutment section 41. An end of the engagement section 42 away from the transition reinforcement section 43 is connected to the abutment section 41. The abutment section 41 is capable of at least abutting against the upper flange 1061. Correspondingly, the abutment section 41 can also be intuitively viewed as a section of structure that extends further from the front flange 422 toward the door body 101. Thus, while the front flange 422 is inserted into the insertion hole 1062, by further providing the abutment section 41, the abutment section 41 abuts against the upper flange 1061. On one hand, this can prevent the front flange 422 and the insertion hole 1062 from separating in the vertical direction, so that the connecting member 4 can only be separated from structures such as the insertion hole 1062 and the engagement recess 1063 at a specific angle, which helps to improve the assembly reliability between the front plate 106 and the connecting member 4. On the other hand, the abutment section 41 can also provide a certain inner side support effect for the front plate 106.

In addition, an end of the abutment section 41 may also abut against a rear side wall of the front plate 106, or there may be a small gap between them, so that if a user closes the door with excessive force causing the front plate 106 to be impacted and undergo slight deformation or displacement backward, the abutment section 41 can provide a certain support and buffering effect for the front plate 106.

### Embodiment 4

Based on any of Embodiments 1-3, for the dual-magnetron cooking appliance proposed in the present application, the dual magnetrons tend to generate more heat within the cooking cavity 110, thereby increasing the exhaust demand of the cooking cavity 110, whereas conventional air guide hoods cannot withstand continuous operation in high-temperature environments, resulting in low exhaust efficiency and susceptibility to damage; moreover, conventional air guide hoods are often integrally formed, leading to high cost and inconvenience for mold removal and subsequent maintenance.

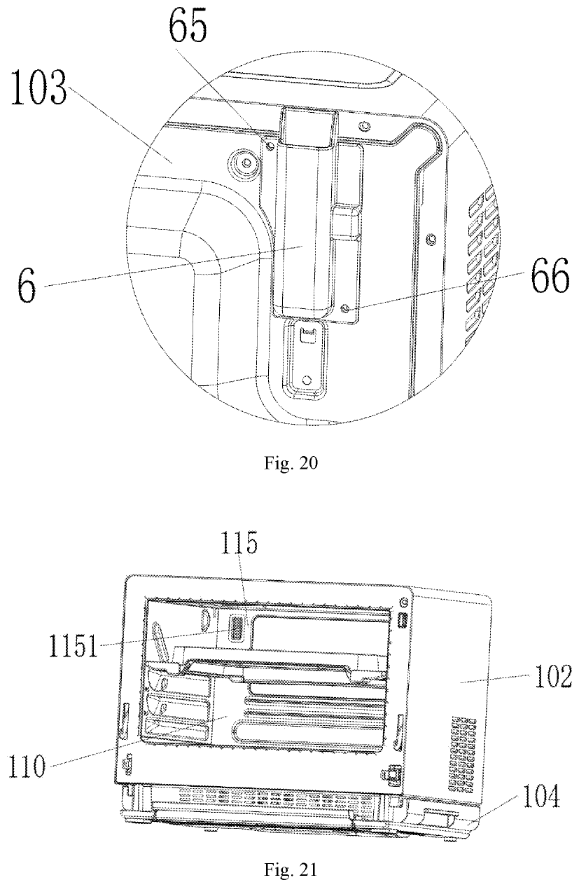

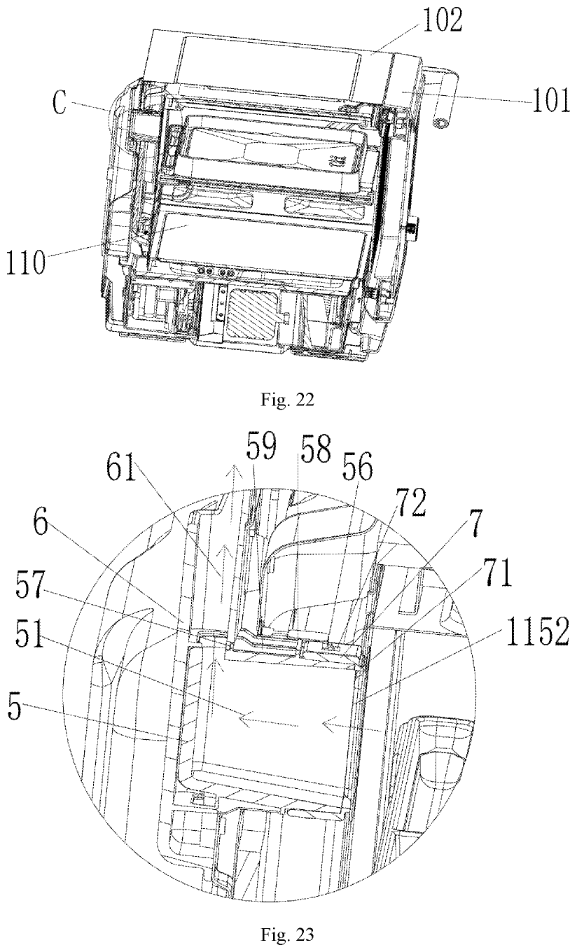

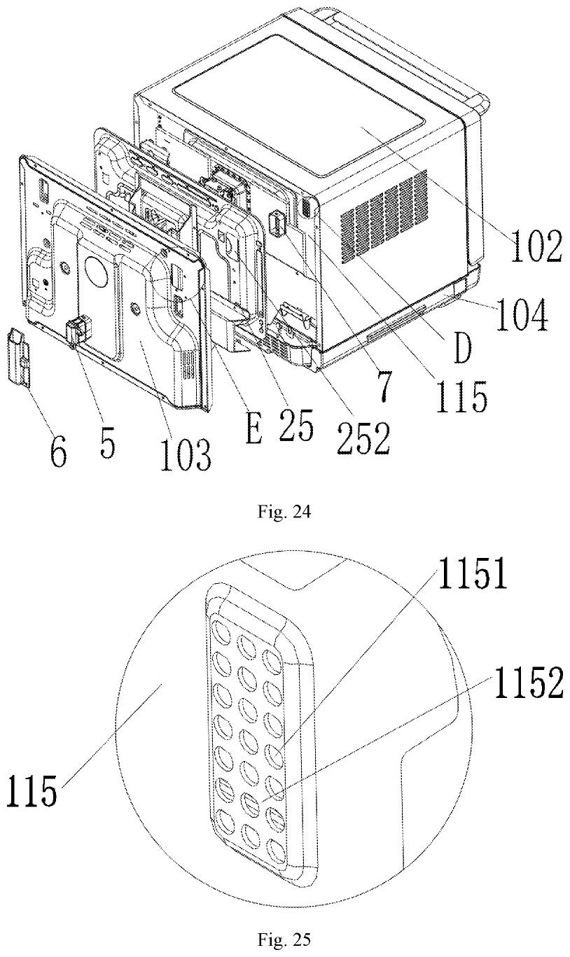

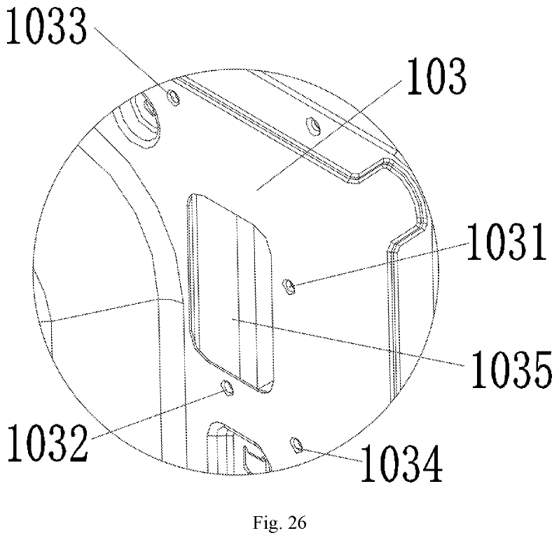

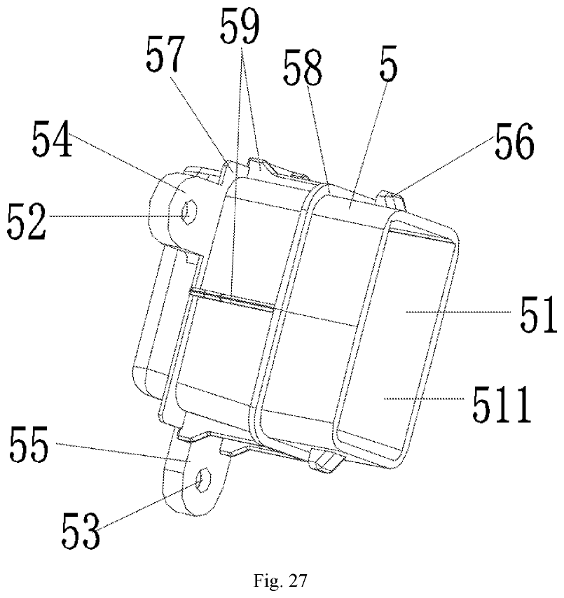

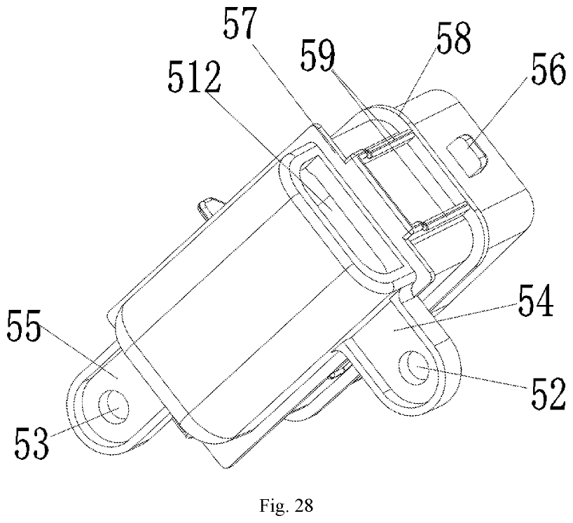

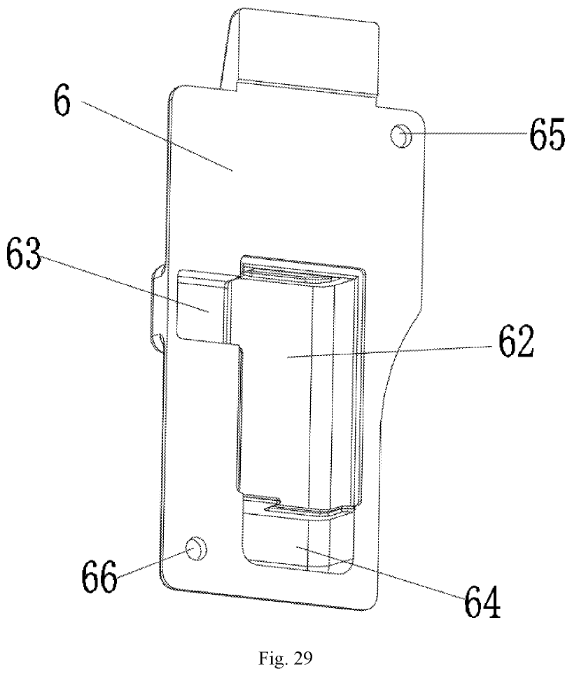

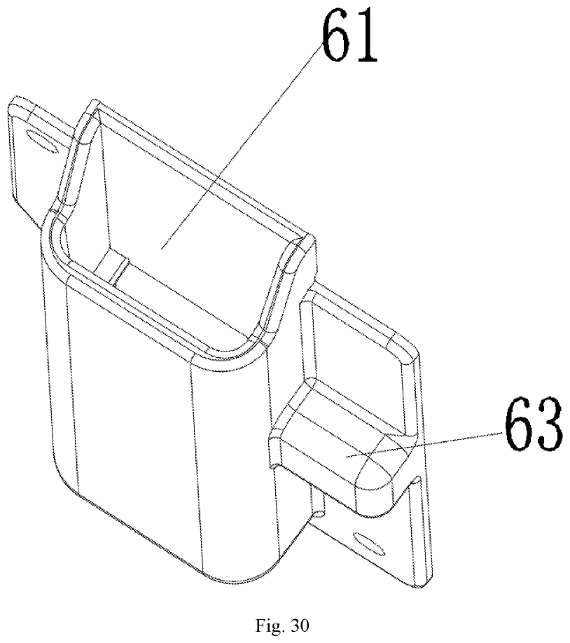

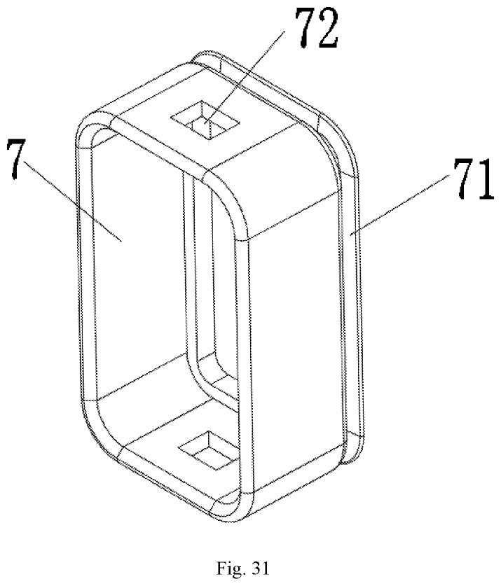

To solve the above technical problems, as shown in FIGS. 19-31, the present embodiment further improves the exhaust structure of the cooking appliance based on any of Embodiments 1-3.

The cooking appliance comprises an inner cavity assembly 11 and an exhaust structure, wherein the inner cavity assembly 11 has a cooking cavity 110 therein, an exhaust port 1151 is provided at a position near the top on the rear plate 115 of the inner cavity assembly 11, so that water vapor generated during food heating can be discharged outside the cooking cavity 110 through the exhaust port 1151;

The exhaust structure comprises:

A first exhaust cover 5, wherein the first exhaust cover 5 is disposed at a rear side of the exhaust port 1151, a first exhaust cavity 51 is provided inside the first exhaust cover 5, and the exhaust port 1151 is in communication with the first exhaust cavity 51;

A second exhaust cover 6, wherein the first exhaust cover 5 is disposed inside the second exhaust cover 6, the first exhaust cover 5 and the second exhaust cover 6 form a double-layer structure, further enhancing gas discharge effectiveness and better withstanding high-temperature environments to meet high-temperature air discharge requirements; a second exhaust cavity 61 is provided inside the second exhaust cover 6, the first exhaust cavity 51 is in communication with the second exhaust cavity 61, and the first exhaust cover 5 and the second exhaust cover 6 are separately disposed.

The exhaust structure according to this embodiment has the following beneficial effects: First, the first exhaust cover 5 and the second exhaust cover 6 form a double-layer exhaust structure, which can meet high-temperature air discharge requirements, improves exhaust efficiency and is not easily damaged, ensuring stable operation of the cooking appliance. Second, the first exhaust cover 5 and the second exhaust cover 6 are separately disposed, resulting in low cost and convenient demolding. Third, the position of the exhaust structure is very concealed, not affecting the aesthetic appearance of the microwave oven.

Meanwhile, in combination with the additional heating of the inner cavity assembly 11 by the heating assembly 3 in Embodiment 2, the plate structure of the entire inner cavity assembly 11 has a relatively high temperature, such that water vapor generated by heating food in the cooking cavity 110 will not form condensed water even when in contact with the inner wall of the cooking cavity 110 (i.e., the plate structure of the inner cavity assembly 11), ensuring that the vast majority of water vapor generated by heating food is discharged through the exhaust port 1151, thereby effectively preventing the occurrence of condensed water in the cooking cavity 110.

Furthermore, since the exhaust port 1151 is located at a position near the top of the rear plate 115, correspondingly, the exhaust structure is also disposed at this position, the heating assembly 3 in Embodiment 2 is preferably disposed between the top plate 111 and the top insulation member 201, adjacent to the exhaust port 1151 and the exhaust structure, which causes the exhaust port 1151 and the exhaust structure to be in a relatively high-temperature local environment, thereby avoiding condensation of water vapor at the exhaust port 1151 and the exhaust structure, ensuring that water vapor generated in the cooking cavity 110 can be discharged while maintaining a gaseous state.

The first exhaust cavity 51 includes a first inlet 511 and a first outlet 512. The first exhaust cavity 51 is horizontally disposed inside the first exhaust cover 5. The first inlet 511 is disposed facing forward of the first exhaust cover 5. The position of the first inlet 511 is designed to facilitate smooth entry of gas into the first exhaust cavity 51. A limiting edge 57 is disposed on the exterior of the first exhaust cavity 51 on the side away from the exhaust port 1151. The first outlet 512 is disposed on the rear side of the limiting edge 57. The first outlet 512 is disposed facing upward of the first exhaust cover 5. This design facilitates gas flow within the first exhaust cavity 51 and smooth discharge, while reducing the residence time of gas inside the first exhaust cover 5 and improving exhaust efficiency.

The rational layout of the first inlet 511 and the first outlet 512 ensures that gas can smoothly enter the first exhaust cavity 51 and be discharged smoothly, reducing the residence time of gas inside the first exhaust cover 5 and improving exhaust efficiency.

A reinforcing edge 58 is disposed on the exterior of the first exhaust cavity 51 on the side proximate to the exhaust port 1151. The reinforcing edge 58 enhances the structural strength of the first exhaust cover 5. A reinforcing structure 59 is disposed between the limiting edge 57 and the reinforcing edge 58. The design of the reinforcing structure 59 further enhances the structural strength of the first exhaust cover 5. It should be noted that this application does not impose excessive limitations on the form and number of the reinforcing structure 59, but for ease of understanding, this application provides an example in which the reinforcing structure 59 is a reinforcing rib, and the number of reinforcing structures 59 is six. This application is not limited to this example.

A sealing connection sleeve 7 is disposed on the first exhaust cover 5 on the side proximate to the exhaust port 1151. The sealing connection sleeve 7 is used for sealing connection with the rear plate 115. The use of the sealing connection sleeve 7 can significantly improve the overall sealing performance of the exhaust structure and reduce the risk of gas leakage. Specifically, one end of the sealing connection sleeve 7 is connected to the rear plate 115, and the other end of the sealing connection sleeve 7 is connected to the first exhaust cover 5. This design can ensure the overall sealing performance of the exhaust structure, avoiding environmental pollution or safety hazards that may be caused by gas leakage; in addition, it also improves the structural strength of the exhaust structure.

An exhaust protrusion 1152 is disposed on the rear plate 115. The exhaust port 1151 is disposed on the exhaust protrusion 1152, enhancing the structural strength of the exhaust port 1151. A connection edge 71 is disposed on the sealing connection sleeve 7 on the side proximate to the rear plate 115. The connection edge 71 is sleeved on the periphery of the exhaust protrusion 1152. A limiting protrusion 56 is disposed on the first exhaust cover 5. A limiting groove 72 is disposed on the sealing connection sleeve 7 on the side away from the rear plate 115. The limiting groove 72 cooperates with the limiting protrusion 56.

The cooking appliance includes a rear housing 103, the rear housing 103 is disposed on a rear side of the rear plate 115, and the first exhaust cover 5 is detachably connected to the rear housing 103, ensuring secure installation of the first exhaust cover 5 while facilitating disassembly and maintenance. Specifically, a first connection hole 52 and a second connection hole 53 are provided on the first exhaust cover 5, a fifth connection hole 1031 and a sixth connection hole 1032 are provided on the rear housing 103, the first connection hole 52 cooperates with the fifth connection hole 1031, and the second connection hole 53 cooperates with the sixth connection hole 1032, ensuring secure installation of the first exhaust cover 5 while facilitating disassembly and maintenance. Accordingly, on the basis of the arrangement of the respective connection holes, the first exhaust cover 5 and the rear housing 103 are assembled by means of fasteners.

A first connection protrusion 54 and a second connection protrusion 55 are provided on the first exhaust cover 5, the first connection hole 52 is provided on the first connection protrusion 54, and the second connection hole 53 is provided on the second connection protrusion 55.

An accommodating cavity 62 is provided in the second exhaust cover 6, the accommodating cavity 62 is used for installing the first exhaust cover 5, and through such design, the first exhaust cover 5 can be stably embedded into the second exhaust cover 6 to form a double-layer exhaust structure. The second exhaust cavity 61 is disposed above the accommodating cavity 62, the second exhaust cavity 61 is vertically disposed inside the second exhaust cover 6 such that the second exhaust cavity 61 extends upward in a vertical direction and communicates with the external environment, and this arrangement facilitates more natural upward movement and discharge of gas while reducing the residence time of gas inside the second exhaust cover 6 and improving exhaust efficiency. A first relief groove 63 and a second relief groove 64 are provided on the second exhaust cover 6, the first relief groove 63 is used for accommodating the first connection protrusion 54, and the second relief groove 64 is used for accommodating the second connection protrusion 55.

In addition, the second exhaust cover 6 is detachably connected to the rear housing 103, ensuring secure installation of the second exhaust cover 6 while facilitating disassembly and maintenance. Specifically, a third connection hole 65 and a fourth connection hole 66 are provided on the second exhaust cover 6, a seventh connection hole 1033 and an eighth connection hole 1034 are provided on the rear housing 103, the third connection hole 65 cooperates with the seventh connection hole 1033, and the fourth connection hole 66 cooperates with the eighth connection hole 1034, ensuring secure installation of the second exhaust cover 6 while facilitating disassembly and maintenance. Accordingly, on the basis of the arrangement of the respective connection holes, the second exhaust cover 6 and the rear housing 103 are assembled by means of fasteners.

For the rear frame 25 at the rear plate 115, a first slot 252 is provided on the rear frame 25, and a second slot 1035 is provided on the rear housing 103, the first slot 252 and the second slot 1035 are used for accommodating the first exhaust cover 5, thereby ensuring normal assembly of the exhaust structure and also preventing the exhaust structure from causing spatial interference with the insulation frame assembly 2 and the rear housing 103.

In the present invention, for any cooking appliance, such as microwave ovens, steam ovens, and the like, the technical content described in this embodiment can be adopted. On the basis of the relevant structures and assembly relationships provided in the present application, the cooking appliance further includes conventional components such as a door body 101, a main housing 102, a rear housing 103, electrical control components, and the like. In view of the fact that these conventional components can all adopt existing technology, no further description will be provided here.

The above descriptions are merely preferred embodiments of the present invention and are not intended to limit the present invention. Any modifications, equivalent substitutions, improvements, etc., made within the spirit and principles of the present invention shall be included within the protection scope of the present invention.

1. A cooking appliance comprising:
a thermal insulation cavity assembly, the thermal insulation cavity assembly comprising an inner cavity assembly and an insulation frame assembly arranged sequentially from inside to outside, an insulation member disposed between the inner cavity assembly and the insulation frame assembly, the insulation member snap-fitted with the insulation frame assembly, and the insulation frame assembly connected to the inner cavity assembly.

2. The cooking appliance of claim 1, wherein at least a portion of the insulation frame assembly is connected to the inner cavity assembly through a fastener, a mounting space is formed between a side of the insulation frame assembly facing the inner cavity assembly and an outer side wall of the inner cavity assembly, and the insulation member is disposed in the mounting space.

3. The cooking appliance of claim 1, wherein a plurality of limiting pieces are disposed on a side of the insulation frame assembly facing the inner cavity assembly, the limiting pieces abut against an outer edge of the insulation member, and/or, the insulation member is provided with insertion holes, and the limiting pieces are capable of penetrating through the insertion holes.

4. The cooking appliance of claim 1, wherein the insulation frame assembly comprises a top frame, a left side frame, a bottom frame, a right side frame, and a rear frame, the top frame, the left side frame, the bottom frame, and the right side frame are sequentially connected end to end and enclose an accommodating space, the inner cavity assembly is disposed within the accommodating space; the rear frame is connected to the inner cavity assembly, and/or, the rear frame is connected to at least one of the top frame, the left side frame, the bottom frame, and the right side frame.

5. The cooking appliance of claim 4, wherein the rear frame is at least connected to a rear plate of the inner cavity assembly.

6. The cooking appliance of claim 4, wherein the cooking appliance comprises a front plate and a connecting member, the front plate is connected to the inner cavity assembly, and at least any one of the top frame, the left side frame, the bottom frame, and the right side frame is capable of being connected to the front plate through the connecting member.

7. The cooking appliance of claim 6, wherein the cooking appliance comprises a door body, the connecting member is provided on a side of the front plate facing away from the door body, one end of the connecting member is engaged with the front plate, and the other end is connected to the top frame in a detachable manner.

8. The cooking appliance of claim 7, wherein the connecting member comprises an engagement section, a transition reinforcement section, and a mounting section connected in sequence, the engagement section is engaged with the front plate, and the mounting section is connected to the top frame.

9. The cooking appliance of claim 8, wherein the top frame is provided with a mounting protrusion, the mounting protrusion is provided with a mounting hole, the mounting section is provided with an installation hole, the mounting hole and the installation hole are connected through a fastener; the mounting protrusion is provided with an insertion opening, the mounting section is provided with an insertion plate, and the insertion plate is capable of being inserted into the insertion opening.

10. The cooking appliance of claim 8, wherein a top portion of the front plate is provided with an upper flange, the upper flange has a insertion hole formed therein, a side of the engagement section facing away from the transition reinforcement section is provided with a front flange, the front flange is capable of being inserted into the insertion hole and abutting against the insertion hole; the upper flange is provided with an engagement recess on a side of the insertion hole facing away from the door body, a side of the engagement section adjacent to the upper flange forms an clamping groove, the front flange is inserted into the insertion hole, and the clamping groove is engaged with the engagement recess.

11. The cooking appliance of claim 10, wherein the connecting member comprises an abutment section, an end of the engagement section remote from the transition reinforcement section is connected to the abutment section, and the abutment section is capable of at least abutting against the upper flange.

12. The cooking appliance of claim 4, wherein the cooking appliance comprises a fixing member, the fixing member is disposed between the top frame and a top plate of the inner cavity assembly, and is connected to the top frame and the top plate.

13. The cooking appliance of claim 12, wherein the top frame is provided with a fixing region, the top plate is provided with a mounting groove, a lower end of the fixing member is disposed in the mounting groove and is connected to the mounting groove, and an upper end of the fixing member is connected to the fixing region.

14. The cooking appliance of claim 1, wherein the cooking appliance comprises a heating assembly, the heating assembly is disposed between the inner cavity assembly and the insulation member, and an insulation structure is provided on an outer side of the insulation frame assembly.

15. The cooking appliance of claim 14, wherein the insulation member between a top plate of the inner cavity assembly and a top frame of the insulation frame assembly is designated as a top insulation member; the heating assembly is disposed between the top plate and the top insulation member, an upper insulation layer is provided on a side of the top frame remote from the top insulation member; and the top insulation member and the upper insulation layer are respectively engaged with the top frame.

16. The cooking appliance of claim 15, wherein the heating assembly comprises a terminal, a first insulation sheet, a heating element, and a second insulation sheet arranged sequentially from top to bottom, wherein the terminal is connected to the heating element.

17. The cooking appliance of claim 16, wherein the first insulation sheet is provided with a wire routing hole, and the terminal is connected to the heating element through the wire routing hole; the top frame is provided with an access port, the top insulation member is provided with a clearance opening, and the access port and the clearance opening are directly opposite to each other and both located above the terminal; the top frame is provided with a third insulation sheet above the access port, an upper surface of the top frame is provided with a limiting claw, and the third insulation sheet is capable of engaging with the limiting claw; the first insulation sheet, the second insulation sheet, and the third insulation sheet are all mica sheets.

18. The cooking appliance of claim 1, wherein the cooking appliance comprises an exhaust structure, a rear plate of the inner cavity assembly is provided with an exhaust port, and the exhaust structure comprises:
a first exhaust cover, wherein the first exhaust cover is disposed at a rear side of the exhaust port, a first exhaust cavity is provided inside the first exhaust cover, and the exhaust port is in communication with the first exhaust cavity; and
a second exhaust cover, wherein the first exhaust cover is disposed inside the second exhaust cover, a second exhaust cavity is provided inside the second exhaust cover, the first exhaust cavity is in communication with the second exhaust cavity, and the first exhaust cover and the second exhaust cover are separately provided.

19. The cooking appliance of claim 18, wherein the second exhaust cover is provided with an accommodating cavity for mounting the first exhaust cover, the second exhaust cavity is arranged above the accommodating cavity, and the second exhaust cavity is arranged vertically inside the second exhaust cover.

20. The cooking appliance of claim 18, wherein the cooking appliance comprises a rear housing, the rear housing is arranged on a rear side of the rear plate, the first exhaust cover and the second exhaust cover are respectively connected to the rear housing; a sealing connection sleeve is arranged on a side of the first exhaust cover adjacent to the exhaust port, and the sealing connection sleeve is sealingly connected to the rear plate.
